(19) United States
(12) Patent Application Publication
(10) Pub. No.: US 2017/0241387 A1
(43) Pub. Date: Aug. 24, 2017

(54) Filter unit, filter system, and motor vehicle with filter system

(71) Applicant: MANN+HUMMEL GMBH, Ludwigsburg (DE)

(72) Inventors: Karl-Ernst Hummel, Bietigheim-Bissingen (DE); Michael Fasold, Auenwald (DE); Ulrich Dehnen, Kornwestheim (DE); Christopher Marc Sturgess, Korntal (DE); Stefan Eichinger, Gerlingen (DE); Thomas Friederich, Stuttgart (DE); Joerg Menssen, Eschede (DE); Armando Labarta, Ludwigsburg (DE)

(21) Appl. No.: 15/431,024

(22) Filed: Feb. 13, 2017

(30) Foreign Application Priority Data
Feb. 18, 2016 (DE) 10 2016 001 852.6

(51) Int. Cl. F02M 37/22; F01M 11/03; B01D 35/30; B01D 29/05; B01D 29/52

(52) U.S. Cl. CPC F02M 37/22; B01D 29/05; B01D 29/52; B01D 35/303; F01M 11/03

(57) ABSTRACT

The invention relates to a filter unit, a filter system (44b) with at least two filter units, and to a motor vehicle with a filter system (44b). A filter bowl (12d-e) of the filter unit is formed by a base and a cover. Embodied in a side wall of the base are at least two access openings to an antechamber or collection chamber (34a-b) in the filter bowl (12d-e). Embodied integrally with the cover is a collection line segment or supply segment (26d-e) that leads from a clean chamber or an unfiltered side antechamber in the filter bowl (12d-e) to at least two open ends (28l). The inventive filter system (44b) has at least two inventive filter units, and fluid may flow through their filter elements (30, 30a-d), which are switched in parallel. The invention facilitates the space-saving arrangement of filter units and filter systems (44b) in constricted and/or complexly shaped installation spaces, especially in motor vehicles.

### TECHNICAL FIELD

The invention relates to a filter unit, a filter system, and a motor vehicle with a filter system.

### BACKGROUND

Filter elements are used in motor vehicles, for instance, to remove impurities from operating fluids like fuel and oil. Typically, exactly one filter element is provided for a fluid to be filtered. The installation size of the filter element limits a maximum possible volume flow of the fluid to be filtered. However, the installation space available is not always large enough or shaped as needed.

US 2005/004 555 2 A1 describes a filter system having a plurality of hollow cylindrical filter housings that are open at the top. Each filter housing is closed at the top by a filter head, wherein the filter heads are embodied to connect to one another filter housings arranged in close proximity to each other. To this end, the filter heads are mounted in a guide rail and connected via short connecting pieces that are inserted into corresponding openings in the filter heads. The filter system is thus suitable for an arrangement of the filter housings directly adjacent to one another and along an imaginary straight line. The filter heads and the connecting pieces are complicated to produced.

Known from EP 0 991 457 B1 is a filter system in which a plurality of separate filter housings are each connected to a filter element via special filter heads onto which the filter housings are screwed. At the top, each filter housing has an opening that spans its entire cross-section and that is covered by a filter head, and into which inlet and outlet lines of the filter head open. The filter heads are therefore complex in design and increase the installation height of the filter system.

### SUMMARY

It is an object of the invention to create a filter unit that is simple and cost-effective to produce and that may be integrated into a filter system in a flexible manner. It is furthermore an object of the invention to provide a filter system that may be arranged even in narrow installation spaces that have complex shapes, in particular non-contiguous shapes. It is furthermore an object of the invention to create a motor vehicle having a filter system, wherein the filter system may be integrated in a manner as space-saving as possible.

According to the invention, a filter unit for a fluid to be filtered, especially fuel or oil, of a motor vehicle is provided, wherein the filter unit has a filter bowl in which is arranged a filter element that divides the filter bowl into a first chamber and a second chamber. Fluid to be filtered may be introduced on the unfiltered side into the unfiltered side of the first or second chamber. Following filtration through the filter medium, clean-side filtered fluid may be removed from the corresponding second and first chambers that form the clean chamber. The filter bowl is formed from a base and a cover, wherein the base has a bottom element and a side wall between the bottom element and the cover. In principle the filter bowl may have any cross-sectional shape. Thus the cross-section may be, for instance, triangular, rectangular, oval, or preferably round. The base is advantageously embodied in one piece. This simplifies production and offers cost advantages. Alternatively, the base may also be embodied in multiple parts. The cover is advantageously joined to the base in a fluid-tight manner. I.e., a separating line between the cover and the base is sealed. The cover has a line segment. The line segment is preferably embodied integrally with the cover. The line segment is open towards the second chamber, which forms the clean chamber or an unfiltered-side antechamber, depending on the flow direction. Filtered fluid may thus flow out of the clean chamber into the line segment to be removed from the filter unit via the line segment, or may be supplied to the unfiltered antechamber of the filter unit. The line segment has at least two open ends. The open ends may connect additional line segments of additional filter units or may connect of other line elements. Embodied in the side wall of the base are at least two access openings to the first chamber, which, corresponding to the flow direction, forms an unfiltered-side antechamber or a clean chamber. The access openings are typically not covered by the cover. The access openings are preferably also not delimited by the cover. The access openings open the filter bowl preferably radially when the filter bowl is embodied essentially as a cylinder. Fluid to be filtered may flow into the first chamber and out of the first chamber through the access openings. The filter unit may be configured in a particularly compact manner, for instance especially flat, due to the line segment integrated into the cover of the filter bowl. Moreover, via the at least two open ends of the line segment and the at least to access openings on the base, the inventive filter unit may be flexibly combined with additional filter units to create a filter system. To this end, one open end of the line segment and one access opening of a filter unit may be connected to one open end of a line segment and one access opening of another filter unit. In particular, using the two access openings and the two open ends of the collection line segment, it is possible to arrange two or more filter units in one parallel combination so that fluid flows through the filter units in parallel. Unneeded access openings and open ends of line segments may be closed with blind plugs. In this way, each filter unit may be constructed identically regardless of its position in use, which simplifies manufacture.

One possible embodiment is characterized in that an inner width of the filter bowl is greater than a total height of the filter bowl. It is particularly preferred that the inner width is at least twice the total height of the filter bowl. This makes it possible to embody the filter unit very flat. A sufficiently large flow volume of fluid may still be filtered, however, because of the relatively large inner width. The total height of the filter bowl is preferably less than 8 cm, particularly preferably less than 6 cm.

In one alternative embodiment, a total height of the filter bowl is greater than one inner width of the filter bowl and especially is at least twice one inner width of the filter bowl. Because of this, particularly deep but narrow installation spaces may be used at the usage site for the filter unit. However, with the appropriate installation space, height and inner width may also be largely the same.

In one particularly advantageous embodiment, it is provided that the base and the cover are bonded to one another, in particular are welded or glued to one another. In this way a fluid-tight connection may be reliably attained. Such a connection may also be produced efficiently. The filter element is then securely integrated in the filter bowl, i.e., it may not be exchanged.

Also preferred is an embodiment in which embodied on the base are at least two fittings, at each of which one of the access openings to the first chamber is embodied. The fittings may in particular be embodied like a short, tube-like projection on the base. The fittings open in the access opening. Line elements like tube elements or pipe elements may be connected to the base in a particularly simple manner using the fittings.

According to the invention, the filter element may be embodied as a round filter element, in particular with a star-shaped pleated filter medium. This makes it possible to provide in the filter element a filter surface area of the filter medium that is as large as possible. The filter bowl is typically embodied essentially in the shape of a cylinder. Alternatively, especially in connection with a filter bowl embodied flat, the filter element may also be embodied as a so-called flat element from a folded filter medium. In this case, the filter bowl is typically embodied in a rectangle.

In addition to the filtration property, the filter element may also have a water separation function or a water separation element may be arranged jointly with the filter element in the filter bowl. Moreover, a heating device and/or one or a plurality of sensors may be added as separate components or as a component of the filter element together with the filter element in the filter bowl.

The base and/or the cover may in particular be produced from a polyamide, in particular PA66. Polyamide is easy to process and is resistant to oils and fuels.

Furthermore in the scope of the invention is a filter system for a motor vehicle, the filter system comprising at least two inventive filter units and characterized in that the first chambers of the filter units are connected to one another to form a first chamber system and the line segments are connected to one another to form to a composite line so that the fluid can flow through the filter elements in parallel.

The filters are thus switched in parallel. Because of this, a large, effective filter system may be obtained from small individual filter units. By using filter units that are independent of one another, the filter system may be flexibly adapted to a wide variety of installation configurations. In particular, it is not necessary to have a contiguous, compact installation space as for a conventional large filter element. On the contrary, the filter units of the inventive filter system may be disposed in a plurality of separate small installation chambers that are spaced apart from one another. For instance, intermediate spaces present in an engine compartment or in the area of an undercarriage may be used for mounting the inventive filter system.

In a preferred embodiment, the connection of the first chambers and/or of the line segments comprises a tube element and/or a pipe element. Tube elements are particularly easy to adapt to the installation configuration of the at least two filter units. Tube elements are suitable in particular when a relative position of the filter units to one another changes during operation of the filter system. Pipe elements may be embodied to be particularly robust.

One advantageous embodiment is characterized in that at least two of the filter bowls of the at least two filter units differ from one another in terms of their total height and/or cross-sectional surface area and/or cross-sectional shape. Typically the height of one of the filter elements in one of the filter bowls of different total heights is then also greater than the height of the other filter element or elements in the other filter bowl or bowls.

Correspondingly, the filter elements may have different dimensions transverse to the height or may have different diameters. Because of this, the filter system may be adapted particularly well to divided or disjointed installation spaces. In principle, however, filter units having identical filter bowls may also be combined into one filter system.

It is preferably provided that an access opening to the antechamber system is closed with a first blind plug. In this way a plurality of filter units having at least two access openings to the specific first chambers may be used to construct the filter system; in particular structurally identical filter units may be used. Thus on one of the filter units one of the access openings is closed with the first blind plug. On another filter unit, a free access opening that is not connected to another access opening of another filter unit may be used to conduct fluid to be filtered into the antechamber system formed by the first chambers or to conduct the filtered fluid out of the clean chamber formed by the first chambers.

It is preferably also provided that the composite line is closed on one side with a second blind plug. In this way a plurality of filter units having at least two open ends on the specific line segment may be used to construct the filter system; in particular structurally identical filter units may be used. A free end of the composite line may be closed by the second blind plug. At the other end, filtered fluid may then be taken from the composite collection line or fluid to be filtered may be supplied to the composite supply line.

In one advantageous refinement it is provided that the first and the second blind plugs are embodied as one integral double plug. This combines the advantages of the two aforesaid embodiments. In addition, the complexity of assembling and handling the first and second blind plugs may be reduced in that they are combined in the integral double plug.

Also preferred is an embodiment that is characterized in that the filter system comprises an additional bowl through which fluid may flow in series with the filter bowls. Additional devices for fluid treatment may be provided in the additional bowl. In particular, a heating module and/or a water separator and/or one or a plurality of sensors for determining a process variable may be arranged in the additional bowl. The process variable is for instance a fill level, especially a water level, or a variable characterizing the fluid quality. The connection in series can render it unnecessary to provide these devices separately in each of the filter bowls. The additional bowl may be advantageously arranged upstream of the filter bowls in the direction of flow (on the unfiltered side, i.e., upstream of the composite antechamber). Pre-treated fluid is then correspondingly supplied to the filter bowls. If filtered fluid is better suited for being treated in the additional bowl than unfiltered fluid, the additional bowl may advantageously be added downstream.

The invention furthermore relates to a motor vehicle with an inventive filter system. In the past, a sufficiently large, contiguous installation space for a conventional filter system with a single, large central filter had to be provided in motor vehicles. According to the invention, it was recognized that space utilization may be improved in that a motor vehicle is equipped with an inventive filter system. The filter system may be disposed in the motor vehicle according to the invention in smaller intermediate spaces that are arranged in a distributed matter, for instance between other devices in an engine compartment and/or in the area of an undercarriage.

Additional advantages of the invention result from the description and the drawings. The features described in the foregoing and even further refined may be used individually by themselves or with other features in any combination.

### BRIEF DESCRIPTION OF THE DRAWINGS

Drawings:

FIG. 1a is a schematic side view of an inventive filter unit;

FIG. 1b is a schematic view onto the filter unit according to FIG. 1a;

FIG. 1c is a schematic cross-section of the filter unit according to FIG. 1a, 1b;

FIG. 2 is a schematic depiction of a first embodiment of an inventive filter system with three inventive filter units;

FIG. 3a is a schematic side view of a second embodiment of an inventive filter system with two inventive filter units;

FIG. 3b is a schematic cross-section through the filter system in FIG. 3a; and

FIG. 4 illustrates the principle of an inventive motor vehicle with an inventive filter system comprising two inventive filter units and having an additional bowl switched in series with the filter units.

### DETAILED DESCRIPTION

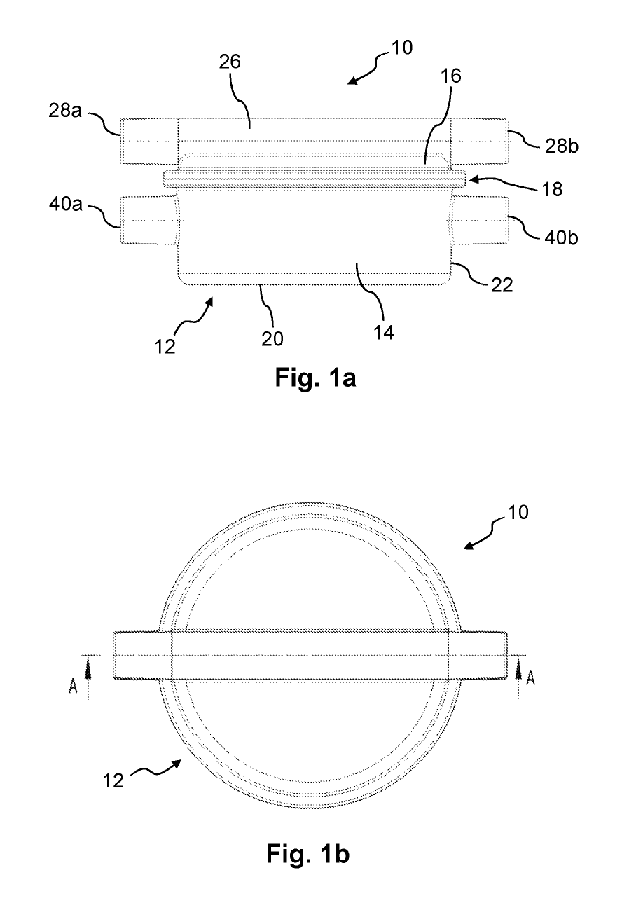

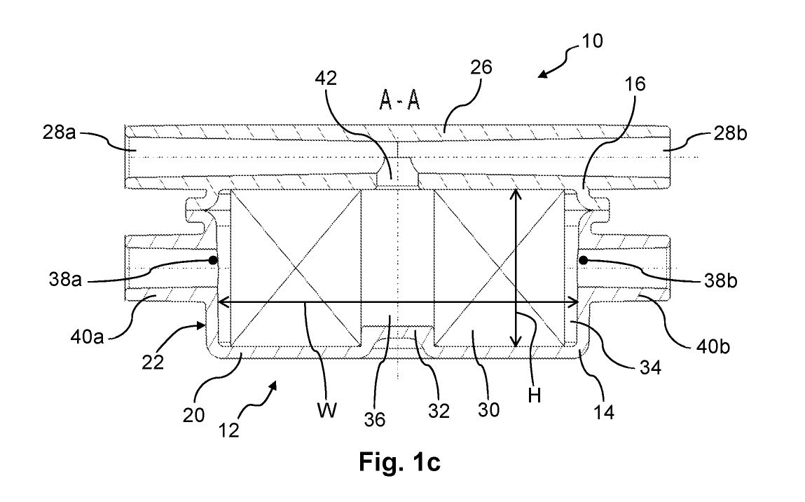

FIG. 1a is a schematic side view of an inventive filter unit 10. The filter unit 10 has a filter bowl 12. The filter bowl 12 is formed from a base 14 and a cover 16. The base 14 and the cover 16 are connected to one another in a fluid-tight manner at a circumferential separating line 18. In this case the fluid-tight connection is realized with a bond produced by welding.

The base has a bottom element 20 and a side wall 22. The side wall 22 connects the bottom element 20 to the cover 16. Two fittings 40a, 40b are embodied here on the side wall 22 of the base 14.

A collection line segment 26 is embodied integrally with the cover 16. The collection line segment 26 here spans the cover 16 diametrically along an (imaginary) straight line. The collection line segment 26 has two open ends 28a, 28b. The open ends 28a, 28b of the collection line segment 26 are arranged above the fittings 40a, 40b of the base 14. I.e., in the embodiment depicted, the fittings 40a, 40b and the open ends 28a, 28b all lie in a common plane.

In the context of the description of the figures, it is assumed that fluid flows through the filter unit 10 from the base to the cover, i.e. the fluid enters through the fittings 40a, 40b of the base 14 into the interior thereof and exits through the collection line segment 26. However, a flow that is the reverse of this is also possible. In that case the fluid enters through the line segment 26 at the cover 16 and flows back out through the fittings 40a, 40b on the base 14. The chambers referred to in the following as clean chamber and antechamber are then correspondingly arranged in the opposite manner.

FIG. 1b is a schematic top view of the filter unit 10 from FIG. 1a. The filter bowl 12 of the filter unit 10 is embodied with a round (circular) cross-section here.

FIG. 1c is a schematic cross-section through the filter unit 10 of FIG. 1a, 1b along plane A-A (see FIG. 1b). A filter element 30 is arranged in the filter bowl 12. The filter element 30 may be a round element, for instance, preferably with a star-shaped folded filter medium (only sketched in). The bottom of the filter element 30 here close in a sealed manner at the bottom element 20 of the base 14 with a central, inwardly oriented projection 32. At its top, the filter element 30 may be positioned for instance in a sealed manner against the cover 16. The filter element 30 thus divides the filter bowl into an antechamber 34 and a clean chamber 36.

Two access openings 38a, 38b to the antechamber 34 are embodied in the side wall 22 of the base 14. One access opening 38a, 38b may be embodied on each of the fittings 40a, 40b, for instance. Line elements such as pipe elements or tube elements (not shown) may be connected to the base 14 via the fittings 40a, 40b in a simple manner and connected to the antechamber 34. When the filter unit 10 is operating, fluid to be filtered may flow via the access openings 38a, 38b at the fittings 40a, 40b into the antechamber 34 or out of the antechamber 34.

The collection line segment 26, which is embodied integrally with the cover 16, may be arranged above the filter bowl 12. The collection line segment 26 is open to the clean chamber 36, for instance by a cut-out 42. When the filter unit 10 is operating, filtered fluid may flow out of the clean chamber 36 into the collection line segment 26 through the cut-out 42. A cross-section of the collection line segment 26 through which fluid can flow may expand from the cut-out 42 to the open ends 28a, 28b. Filtered fluid may be drawn from the filter unit 10 at the open ends 28a, 28b.

The filter unit 10 may be embodied very flat. An installation height H of the filter bowl 12 in this case is significantly smaller than a inner width W of the filter bowl 12. In the embodiment shown, the installation height H of the filter bowl 12 is also equal to a height of the filter element 30. The inner width W may be twice the installation height H, for instance. The installation height H may in particular be less than 4.5 cm.

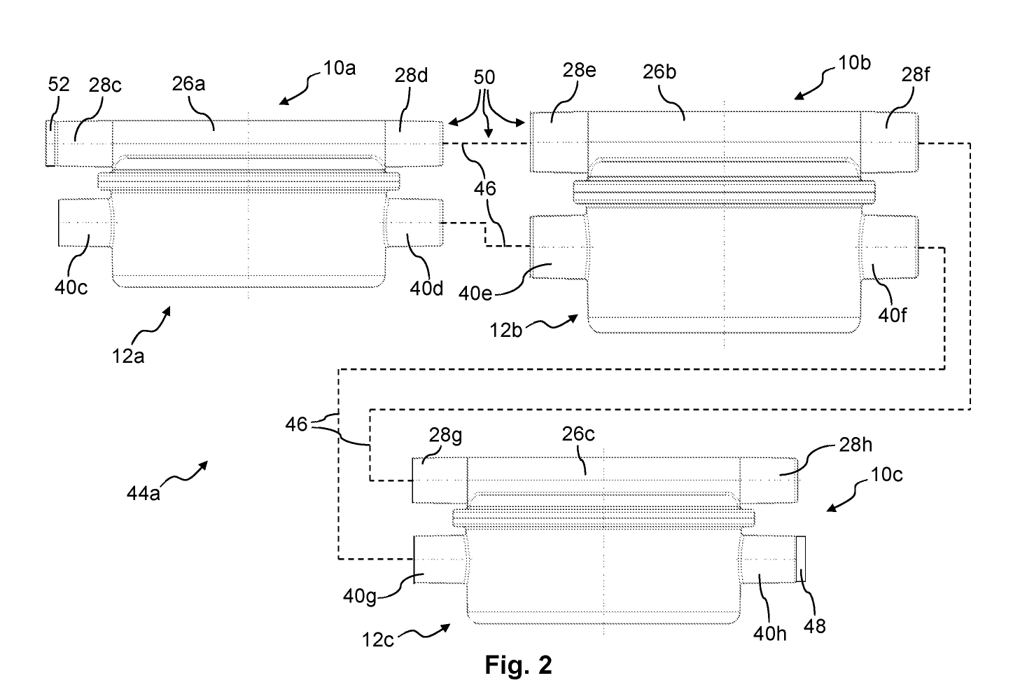

FIG. 2 is a schematic depiction of a first embodiment of an inventive filter system 44a with three inventive filter units 10a-c. Filter bowls. 12a-c of the filter units 10a-c are embodied in different sizes here. For instance, the filter bowl 12b may be taller than the filter bowls 12a and 12c.

Each of the filter bowls 12a-c is embodied with two fittings 40c-h here. In this case, the fittings 40d and 40e as well as 40f and 40g are each connected by line elements 46. The line elements 46 may be tube elements, for instance, that are added to the fittings 40d-40g (not shown in detail). The fitting 40h here is closed by a first blind plug 48. Fluid to be filtered may initially flow through the fittings 40c into the antechamber (covered) in the filter bowl 12a and then into the other antechambers (covered) of the filter bowls 12b and 12c. Unfiltered fluid may be prevented from exiting the filter system 44a by the first blind plug 48.

Embodied on each of the filter bowls 12a-c is a collection line segment 26a-c, each having two open ends 28c-h. The open ends 28d and 28e as well as 28f and 28g are each connected by line elements 46. The line elements 46 may be tube elements, for instance, that are added to the open ends 28d-g (not shown in detail). The collection line segments 26a-c are thus connected to create a composite collection line 50. The open end 28c of the collection line segment 26a or the composite collection line 50 is closed by a second blind plug 52. Filtered fluid may thus flow out of the composite collection line 50 at the open end 28h. In addition, in the depicted embodiment an unfiltered-side inlet for fluid to be filtered is embodied as the fitting 40c and a clean-side outlet for filtered fluid is embodied as the open end 28h at different filter units 10a and 10c.

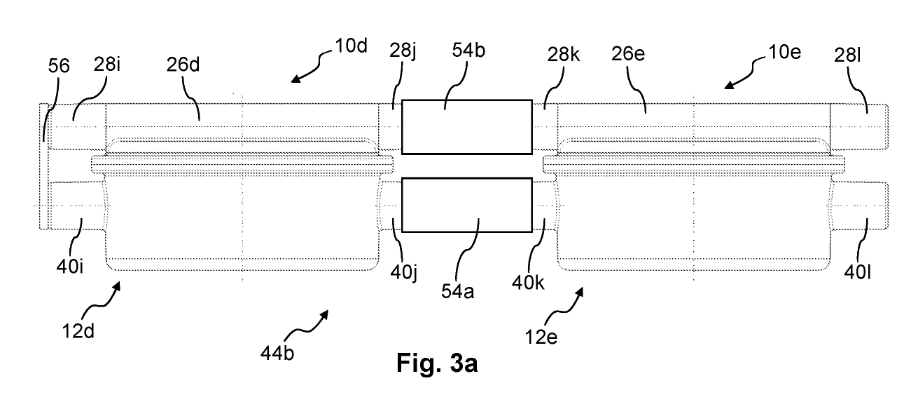

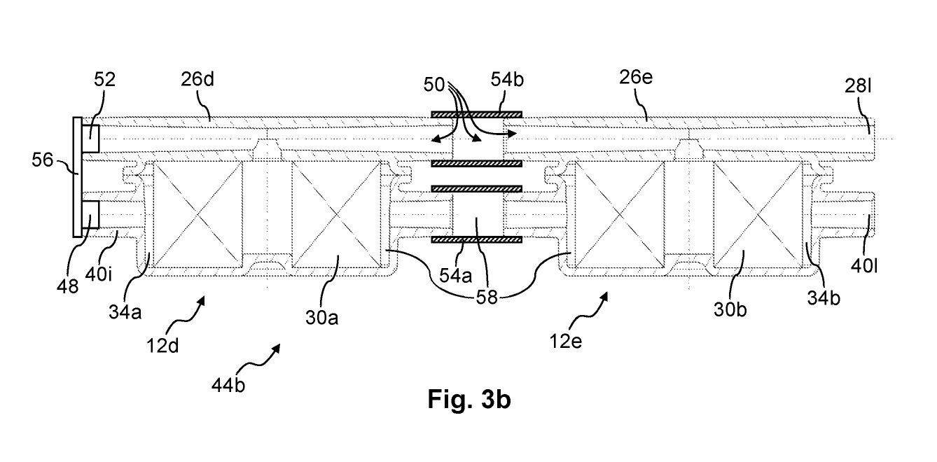

FIG. 3a is a schematic side view of a second embodiment of an inventive filter system 44b with two inventive filter units 10d, 10e. In this case, filter bowls 12d, 12e of the filter units 10d, 10e are each embodied with two fittings 40i-l. The fittings 40j and 40k are connected here such that fluid may flow through them. The connection through which fluid may flow may be formed, for instance, by a pipe element 54a that is added to the fittings 40j, 40k. At the top, each of the filter units 10d, 10e has a collection line segment 26d, 26e. Each collection line segment 26d, 26e itself has two open ends 28i-l. The open ends 28j and 28k may be connected such that fluid may flow through them. The connection through which fluid may flow may be formed, for instance, by a pipe element 54b that is added to the open ends 28j, 28k. The pipe elements 54a, 54b are depicted as very short for purposes of illustration. In practice, the pipe elements 54a, 54b may be embodied significantly longer and, in particular, bent (even multiple times) or angled. The fitting 40i and the open end 28i on the filter unit 10d in this case are closed by an integral double plug 56. In addition, in the embodiment of FIG. 3a, an unfiltered-side inlet for fluid to be filtered is embodied as the fitting 40l and a clean-side outlet for filtered fluid is embodied as the open end 281 on the same filter unit 10e.

In FIG. 3b, the filter system 44b from FIG. 3a is shown schematically in cross-section. The collection line segments 26d, 26e are connected by the pipe element 54b to create a composite collection line 50. Antechambers 34a, 34b in the filter bowls 12d, 12e are connected by the pipe element 54a to create an antechamber system 58.

The integral double plug 56 has a second blind plug 52 with which the composite collection line 50 is closed on one side. The integral double plug 56 furthermore has a first blind plug 48 with which the fitting 40i is closed. Fluid to be filtered may thus flow through the fittings 40l into the antechamber system 58. Following filtration by filter elements 30a, 30b, which are arranged in the filter bowls 12d, 12e, filtered fluid may flow out of the open end 281 of the composite collection line 50. The filter elements 30a and 30b are switched in parallel fluidically. I.e., the fluid may flow either through the filter element 30a or through the filter element 30b. The filtered fluid flows together in the composite collection line 50.

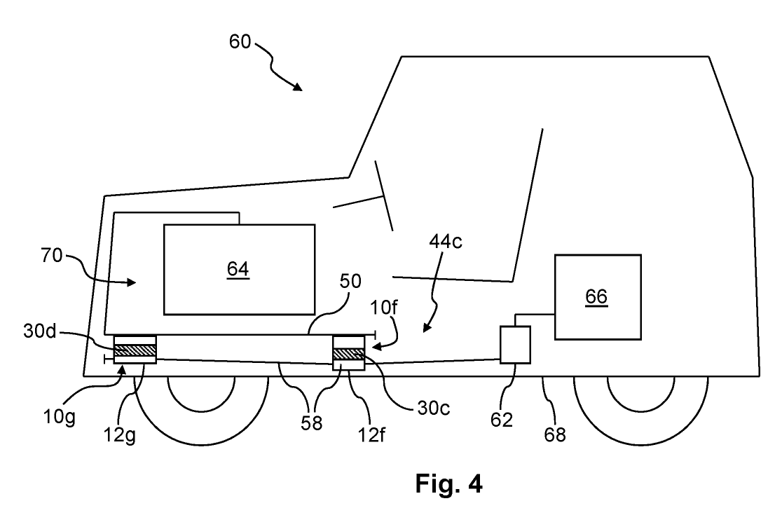

FIG. 4 illustrates the principle of an inventive motor vehicle 60 with an inventive filter system 44c. The filter system 44c comprises two inventive filter units 10f, 10g and one additional bowl 62 switched in series with the filter units 10f, 10g. The motor vehicle furthermore has a drive engine 64 and a fuel tank 66. The filter system 44c or components thereof, especially one or a plurality of the filter units 10f, 10g, may be arranged, for instance, near an undercarriage 68 of the motor vehicle 60 or in intermediate spaces in an engine compartment 70 of the motor vehicle 60.

Fluid to be filtered, in this case fuel, may flow out of the fuel tank 66 into the filter system 44c. The fuel initially flows into the additional bowl 62 of the filter system 44c. A water separator and/or a heating module and/or sensors (not shown) may be arranged in the additional bowl 62, for instance. The fluid may thus be pre-treated by the devices in the additional bowl. In an alternative embodiment, not shown, the additional bowl may also be downstream of the filter units. Moreover, it is possible to integrate the additional functions in one filter bowl with filter unit so that no additional bowl is necessary.

In the depicted embodiment, the fluid thus travels out of the additional bowl 62 into an unfiltered-side antechamber system 58 of the filter system 44c. One filter element 30c, 30d is arranged in each of the filter bowls 12f, 12g of the filter units 10f, 10g, in this case. The filter elements 30c, 30d may be embodied, for instance, as flat elements through which fluid may flow from below to above, preferably with a zig-zag folded filter medium (not shown in detail). However, it is also possible to use so-called hollow elements with an annularly closed folded filter medium through which fluid may flow radially from inside to outside or from outside to inside. Once it has passed through the parallel switched filter elements 30c, 30d, the fluid travels on the clean side into a composite collection line 50. The filtered fluid may be supplied to the drive engine 64 from the composite collection line 50.

In summary, the invention relates to a filter unit 10, 10a-g, a filter system 44a-c with at least two inventive filter units 10, 10a-g, and to a motor vehicle 60 with an inventive filter system 44a-c. A filter bowl 12, 12a-g of the filter unit 10, 10a-g is formed from a base 14 and a cover 16. At least two access openings 38a-b to an antechamber 34, 34a-b in the filter bowl 12, 12a-g are embodied in a side wall 22 of the base 14. Embodied integrally with the cover 16 is a collection line segment 26, 26a-e that leads from a clean chamber 36 in the filter bowl 12, 12a-g to at least two open ends 28a-l. The inventive filter system 44a-c has at least two inventive filter units 10, 10a-g, and fluid may flow through their filter elements 30, 30a-d, which are switched in parallel. The invention facilitates the space-saving arrangement of filter units 10, 10a-g and filter systems 44a-c in constricted and/or complexly shaped installation spaces, especially in motor vehicles 60.

What is claimed is:

1. A filter unit for a fluid to be filtered, of a motor vehicle, comprising:
a filter bowl in which is arranged a filter element that divides the filter bowl into
a first chamber,
a second chamber,
and separates an unfiltered side for fluid to be filtered from a clean side for filtered fluid,
wherein the filter bowl is formed from a base,
a cover,
wherein the base has
a bottom element and
a side wall arranged between the bottom element and the cover,
wherein the cover has a line segment that is open to the second chamber and that has at least two open ends, and
wherein embodied in the side wall of the base are at least two access openings to the first chamber.

2. The filter unit according to claim 1, wherein
the base and the cover are fixedly bonded onto one another.

3. The filter element according to claim 1, wherein
embodied on the base are at least two fittings, at each of which one of the access openings to the first chamber is embodied.

4. The filter unit according to claim 1, wherein
the filter element is a round element having a star-shaped pleated filter medium.

5. A filter system for a motor vehicle, comprising:
at least two filter units according to claim 1,
wherein the first chambers of the filter units are connected to a first chamber system and
the line segments are connected to one another to create a composite collection line so that the fluid can flow through the filter elements in parallel.

6. The filter system according to claim 5, wherein
the connection of the first chambers and/or the line segments comprise a tube element and/or a pipe element.

7. The filter system according to claim 5, wherein
at least two of the filter bowls of the at least two filter units differ from one another in terms of their total height (H) and/or cross-sectional surface area and/or cross-sectional shape.

8. The filter system according to claim 5, wherein
an access opening to the first chamber system is closed with a first blind plug.

9. The filter system according to any of claim 8, wherein
the composite collection line is closed on one side with a second blind plug.

10. The filter system according to claim 9, wherein
the first blind plug and the second blind plug are embodied as an integral double plug.

11. The filter system according to claim 1, wherein the filter system comprises:
an additional bowl through which fluid may flow in series with the filter bowls,
wherein a heating module and/or a water separator and/or at least one sensor are arranged in the additional bowl.

12. A motor vehicle with a filter system according to claim 5.
